(19) United States
(12) Patent Application Publication
(10) Pub. No.: US 2014/0287128 A1
(43) Pub. Date: Sep. 25, 2014

(54) EMULSIFIED LIQUID SEASONING

(71) Applicant: The Nisshin OilliO Group, Ltd., Tokyo (JP)

(72) Inventors: Yasunobu Saito, Yokosuka-shi (JP); Keita Ikegame, Yokosuka-shi (JP)

(73) Assignee: The Nisshin OilliO Group, Ltd., Tokyo (JP)

(21) Appl. No.: 14/296,078

(22) Filed: Jun. 4, 2014

Related U.S. Application Data
(63) Continuation of application No. PCT/JP2012/081299, filed on Dec. 3, 2012.

(30) Foreign Application Priority Data
Dec. 6, 2011 (JP) 2011-267366

(51) Int. Cl. A23L 1/22; A23L 1/24

(52) U.S. Cl. CPC A23L 1/22058; A23L 1/24
USPC 426/602

(57) ABSTRACT

Provided is a low-calorie, low-cholesterol emulsified liquid seasoning in which syneresis, separation, and setting are suppressed. The emulsified liquid seasoning includes a crosslinked starch, an octenyl succinate-treated starch, and a polysaccharide thickener. The emulsified liquid seasoning may contain, in terms of the total amount of emulsified liquid seasoning, 0.3 to 2.2 mass % of the crosslinked starch, 0.5 to 2.5 mass % of the octenyl succinate-treated starch, and 0.2 to 0.6 mass % of the polysaccharide thickener.

### CROSS-REFERENCE TO RELATED APPLICATIONS

This application is a continuation of International Application No. PCT/JP2012/081299, filed Dec. 3, 2012, and claims benefit of priority of Japanese Patent Application No. 2011-267366, filed Dec. 6, 2011. The disclosures of the prior applications are considered part of the disclosure of this application and are herein incorporated by reference.

### TECHNICAL FIELD

The present invention relates to an emulsified liquid seasoning.

### BACKGROUND

In recent years, the health preference of consumers has been rising from concerns such as with the prevention of lifestyle diseases. For this reason, for emulsified liquid seasonings such as dressings, for example, there is demand for products in which the amount of calories or cholesterol has been reduced.

As a method of reducing the calories of emulsified liquid seasonings, decreasing the blending amount of fat and oil in the emulsified liquid seasoning can be exemplified. However, in the case of decreasing the blending amount of fat and oil in an emulsified liquid seasoning, the good taste or body is lost. In addition, when decreasing the blending amount of fat and oil in an emulsified liquid seasoning, since moisture is abundantly blended, the moisture present between emulsified particles in the emulsified liquid seasoning increases, a result of which there is a possibility of moisture precipitating. For this reason, while storing an emulsified liquid seasoning in a storage container or the like, there is a possibility of syneresis (phenomenon of water layer separating from emulsified liquid seasoning) occurring at the bottom of the container.

As a method of preventing syneresis, a method has been known of stabilizing the dispersibility of emulsified particles by blending a polysaccharide thickener into the emulsified liquid seasoning. However, in the case of the blending amount of the polysaccharide thickener in the emulsified liquid seasoning being great, there is a possibility of setting (phenomenon of fluidity of emulsified liquid seasoning being lost and becoming gel form) occurring.

In addition, as a method of reducing the cholesterol of an emulsified liquid seasoning, not using egg yolk as a component in the emulsified liquid seasoning can be exemplified. However, in the case of not using egg yolk as a component in the emulsified liquid seasoning, it is necessary to use starch octenylsuccinate or the like as an emulsifier in place of egg yolk. However, if the blending amount of starch octenylsuccinate or the like is great, there is a possibility of the flavor and texture of the emulsified liquid seasoning becoming inferior. On the other hand, if curbing the blending amount of starch octenylsuccinate, the emulsion stability will decline, and there is a possibility of separation (phenomenon of oil layer separating from emulsified liquid seasoning) occurring.

As a low-calorie, low-cholesterol emulsified liquid seasoning having a small blending amount of fat and oil without using egg yolk, a seasoning of a mayonnaise type containing soy protein (Patent Document 1), an emulsion-type dressing produced by a 2-stage emulsification process (Patent Document 2), etc. have been proposed. However, these technologies cannot be said to sufficiently consider the suppression of syneresis, separation and setting of emulsified liquid seasonings.

As above, it has been difficult to produce a low-calorie, low-cholesterol emulsified liquid seasoning that does not allow syneresis, separation and setting to occur.

[Patent Document 1] Japanese Unexamined Patent Application, Publication No. 2004-350525

[Patent Document 2] Japanese Unexamined Patent Application, Publication No. H07-75522

### DISCLOSURE OF THE INVENTION

### Problems to be Solved by the Invention

The present invention has been made taking such a situation into account, and has an object of providing a low-calorie, low-cholesterol emulsified liquid seasoning for which syneresis, separation and setting are suppressed.

### Means for Solving the Problems

The present inventors have diligently investigated in order to solve the above-mentioned issues, and found that the syneresis, separation and setting of a low-calorie, low-cholesterol emulsified liquid seasoning could be suppressed by blending a crosslinked starch, octenyl succinate-treated starch, and polysaccharide thickener into the emulsified liquid seasoning as components in the emulsified liquid seasoning. More specifically, the present invention provides the following such matters.

According to a first aspect, an emulsified liquid seasoning includes: a crosslinked starch; octenyl succinate-treated starch; and polysaccharide thickener.

According to a second aspect, the emulsified liquid seasoning as described in the first aspect includes in terms of total amount of emulsifier liquid seasoning, 0.3 to 2.2 mass % of the crosslinked starch; 0.5 to 2.5 mass % of the octenyl succinate-treated starch; and 0.2 to 0.6 mass % of the polysaccharide thickener.

According to a third aspect, in the emulsified liquid seasoning as described in the first or second aspect, the crosslinked starch is acetylated adipic acid crosslinked starch, and the octenyl succinate-treated starch is starch sodium octenylsuccinate.

According to a fourth aspect, the emulsified liquid seasoning as described in any one of the first to third aspects includes xanthan gum as the polysaccharide thickener.

According to a fifth aspect, the emulsified liquid seasoning as described in any one of the first to fourth aspects includes tamarind seed gum as the polysaccharide thickener.

According to a sixth aspect, the emulsified liquid seasoning as described in any one of the first to fifth aspects includes 1 to 30 mass % fat and oil in terms of total amount of emulsified liquid seasoning, wherein the fat and oil are liquid at 20° C.

### Effects of the Invention

According to the present invention, a low-calorie, low-cholesterol emulsified liquid seasoning is provided for which syneresis, separation and setting are suppressed.

### PREFERRED MODE FOR CARRYING OUT THE INVENTION

Hereinafter, an embodiment of the present invention will be specifically explained.

### (Emulsified Liquid Seasoning)

An emulsified liquid seasoning of the present invention contains a crosslinked starch, octenyl succinate-treated starch and a polysaccharide thickener as components. By such components being combined and blended, a low-calorie, low-cholesterol emulsified liquid seasoning for which syneresis, separation and setting are suppressed is provided by the present invention.

Emulsified liquid seasoning in the present invention indicates a liquid seasoning that has been emulsified and is oil-in-water type (O/W type), and indicates dressings, tare, sauces and other foodstuff similar to these. Dressing can be exemplified as a preferred form of the emulsified liquid seasoning of the present invention, and more specifically, “emulsified liquid dressings”, etc. defined by Japanese Agricultural Standards (JAS) can be exemplified. It should be noted that semisolid dressings such as mayonnaise are not included in the emulsified liquid seasoning of the present invention.

In addition, hereinafter, low-calorie, low-cholesterol emulsified liquid seasoning of the present invention indicates one in which the blending amount of fat and oil is small without egg yolk being used as a raw material (e.g., in terms of the total amount of emulsified liquid seasoning, the blending amount of oil and fat being 1 to 30 mass %, preferably 5 to 20 mass %, and more preferably 8 to 15 mass %). The fat and oil contained in the emulsified liquid seasoning are not particularly limited, and may be cooking oil that is normally used in the production of emulsified liquid seasonings.

Hereinafter, each component contained in the emulsified liquid seasoning of the present invention will be described in detail.

### (Crosslinked Starch)

Crosslinked starch in the present invention indicates a starch that has been crosslinked by causing starch or processed starch given a functional group such as an acetyl group or hydroxypropyl group, to react with a phosphate group, adipic acid group or the like. It is known that crosslinked starches generally have superior shearing resistance and acid resistance suited to emulsified liquid seasonings. The crosslinked starch of the present invention can suppress setting of the emulsified liquid seasoning by retaining the moisture of the emulsified liquid seasoning to impart moderate viscosity and fluidity to the emulsified liquid seasoning.

Although the crosslinked starches that can be used in the present invention are not particularly limited, for example, it may be one obtained by simultaneously performing crosslinking and processing on a starch, or one obtained by preparing processed starch by first performing processing, and then crosslinking this.

As specific examples of the crosslinked starches that can be used in the present invention, acetylated adipic acid crosslinked starch, acetylated phosphoric acid crosslinked starch, hydroxypropylated phosphoric acid crosslinked starch, etc. can be exemplified. Acetylated adipic acid crosslinked starch is preferable due to ease of obtaining.

The blending amount of crosslinked starch in the emulsified liquid seasoning of the present invention, in terms of the total amount of emulsified liquid seasoning, is preferably 0.3 to 2.2 mass %, more preferably 0.5 to 2.2 mass %, and most preferably 0.8 to 1.7 mass %. In the case of the blending amount of crosslinked starch being small, there is a possibility of syneresis of the emulsified liquid seasoning tending to occur. On the other hand, in the case of the blending amount of crosslinked starch being great, there is a possibility of the starch odor, sticky texture, etc. appearing, and thus the taste and texture of the emulsified liquid seasoning becoming inferior.

### (Octenyl Succinate-Treated Starch)

Octenyl succinate-treated starch in the present invention is a starch arrived at by esterifying potato starch, tapioca starch, corn starch, waxy corn starch, etc. and hydrolysates of these with octenyl succinic acid. The octenyl succinate-treated starch of the present invention can make the emulsion particles in the emulsified liquid seasoning fine, raise the emulsion stability, and suppress syneresis and separation of the emulsified liquid seasoning.

Although the octenyl succinate-treated starches that can be used in the present invention are not particularly limited, for example, those in which one among the carboxylic acid groups in octenyl succinate-treated starch and starch or a hydrolysate thereof constitute an ester can be exemplified. In this case, another carboxylic acid group may be free, or may constitute a salt such as of sodium, potassium, ammonia or amines. Starch sodium octenylsuccinate is preferable due to ease of obtaining.

The blending amount of the octenyl succinate-treated starch in the emulsified liquid seasoning of the present invention, in terms of total amount of emulsified liquid seasoning, is preferably 0.5 to 2.5 mass %, more preferably 1.0 to 2.2 mass %, and most preferably 1.5 to 2.0 mass %. In the case of the blending amount of the octenyl succinate-treated starch being small, the emulsion particles in the emulsified liquid seasoning will hardly become fine, and there is a possibility of lacking smoothness when holding the emulsified liquid seasoning in the mouth. On the other hand, in the case of the blending amount of the octenyl succinate-treated starch being great, there is a possibility of melt-in-mouth inferiority, after-taste inferiority, etc. appearing, and thus the taste and texture of the emulsified liquid seasoning becoming inferior.

### (Polysaccharide Thickener)

A polysaccharide thickener is contained in the emulsified liquid seasoning of the present invention. The polysaccharide thickener of the present invention has functions of stabilizing the emulsification of the emulsified liquid seasoning, and suppressing syneresis and separation of the emulsified liquid seasoning.

The polysaccharide thickeners that can be used in the present invention are not particularly limited; however, xanthan gum is preferable. Xantham gum can stabilize the dispersibility of emulsion particles in the emulsified liquid seasoning by way of the network structure thereof. For this reason, when blending xanthan gum into the emulsified liquid seasoning, it is possible to stabilize the emulsion of the emulsified liquid seasoning, a result of which syneresis and separation of the emulsified liquid seasoning can be suppressed.

Although the other polysaccharide thickeners that can be used in the present invention are not particularly limited, tamarind seed gum, guar gum, locust bean gum, carrageenan, gum Arabic, alginic acids, pectin, pullulan, psyllium seed gum, carboxymethyl cellulose, methylcellulose, microcrystalline cellulose, vegetable gelatin, glucomannan or the like, and combinations of any among these can be exemplified.

For the blending amount of polysaccharide thickener in the emulsified liquid seasoning of the present invention, in terms of total amount of emulsified liquid seasoning, the total of polysaccharide thickeners is preferably 0.2 to 0.6 mass %, the total is more preferably 0.2 to 0.5 mass %, and the total is most preferably 0.2 to 0.45 mass %. In the case of the blending amount of polysaccharide thickener being small, emulsion of the emulsified liquid seasoning will become unstable, and there is a possibility of separation tending to occur. On the other hand, in the case of the blending amount of polysaccharide thickener being great, there is a possibility of setting (phenomenon of fluidity of emulsified liquid seasoning being lost and becoming gel form) occurring.

In the case of xanthan gum being contained as the polysaccharide thickener in the emulsified liquid seasoning of the present invention, the blending amount of xanthan gum is preferably at least 0.05 mass % in terms of the total amount of emulsified liquid seasoning. If the blending amount of xanthan gum is in this range, syneresis of the emulsified liquid season can be suppressed since the dispersibility of the emulsion particles in the emulsified liquid seasoning will be effectively stabilized.

In addition, it is preferable to blend xanthan gum and tamarind seed gum as polysaccharide thickeners into the emulsified liquid seasoning of the present invention. The stability of the emulsion of the emulsified liquid seasoning rises by combining xanthan gum and tamarind seed gum as the polysaccharide thickeners. In the case of combining xanthan gum and tamarind seed gum as polysaccharide thickeners, the blending amount of tamarind seed gum is preferably 0.1 to 0.55 mass %, more preferably 0.3 to 0.45 mass % and most preferably 0.3 to 0.4 mass % in terms of total amount of emulsified liquid seasoning.

In the emulsified liquid seasoning of the present invention, the crosslinked starch, octenyl succinate-treated starch and polysaccharide thickener act without inhibiting the functions of each other. For this reason, according to the present invention, an emulsified liquid seasoning for which syneresis, separation and setting are effectively suppressed is provided that is a low-calorie, low-cholesterol emulsified liquid seasoning. Syneresis and separation of the emulsified liquid seasoning can be evaluated by visually observing the appearance of the emulsified liquid seasoning after centrifuging the emulsified liquid seasoning (observing whether a water layer and/or oil layer separate from the emulsified liquid seasoning). Setting of the emulsified liquid seasoning can be evaluated by visually observing the fluidity of the emulsified liquid seasoning after leaving to stand and storing the emulsified liquid seasoning (observing whether fluidity of the emulsified liquid seasoning is lost, and hardens to gel form).

(Fat and Oil that are Liquid at 20° C.)

Fat and oil that are liquid at 20° C. may be contained in the emulsified liquid seasoning of the present invention. By such fat and oil being contained in the emulsified liquid seasoning, it is possible to impart good taste, body, etc. to the emulsified liquid seasoning.

Although the fat and oil that are liquid at 20° C. that can be used in the present invention are not particularly limited, one fat and oil selected from soybean oil, rapeseed oil, corn oil, coconut oil, palm oil, rice oil, sesame oil, cottonseed oil, sunflower oil, safflower oil, linseed oil, Shiso oil, olive oil, peanut oil, grape seed oil, macadamia nut oil, hazelnut oil, squash seed oil, walnut oil, camellia oil, teaseed oil, perilla oil, borage oil, rice-bran oil, wheat germ oil, flavor oil (herb oil, garlic oil, etc.), or a mixed oil combining at least two among these can be exemplified. In addition, it is possible to use fractionated oil, hydrogenated oil, transesterified oil, etc. of these fats and oils. It is preferable to use vegetable oil (so-called salad oil) prepared so as to be liquid and clear after storing for 5.5 hours at 0° C., from the viewpoint of not inhibiting the taste of the emulsified liquid seasoning and imparting body to the emulsified liquid seasoning.

In the emulsified liquid seasoning of the present invention, the blending amount of fat and oil that is liquid at 20° C. is preferably 1 to 30 mass % relative to the total amount of emulsified liquid seasoning, more preferably 5 to 20 mass %, and most preferably 8 to 15 mass %. It should be noted that, although 30 to 50 mass % fat and oil is contained in normal emulsified liquid seasoning, the total amount of fat and oil (i.e. total amount of fat and oil irrespective of whether being fat and oil that is liquid at 20° C.) is blended so as to be a lower amount of fat and oil than this value in the emulsified liquid seasoning of the present invention.

In the case of the blending amount of fat and oil that is liquid at 20° C. being less than the above-mentioned range, it becomes difficult to impart sufficiently good taste and body to the emulsified liquid seasoning. On the other hand, in the case of the blending amount of fat and oil that is liquid at 20° C. being greater than the above-mentioned range, the calorie value of the emulsified liquid seasoning will increase, and thus it becomes difficult to answer the needs for low-calorie foodstuff. In addition, in the case of the blending amount of fat and oil that is liquid at 20° C. being greater than the above-mentioned range, possibility of separation of the oil of the emulsified liquid seasoning occurring increases.

### (Production Method of Emulsified Liquid Seasoning of Present Invention)

The emulsified liquid seasoning of the present invention can be produced following a typical production method of emulsified liquid seasonings. For example, a method that heats and stirs the raw materials other than fat and oil (for example, crosslinked starch, octenyl succinate-treated starch, polysaccharide thickener, acetic acid, salt, etc.) to uniformly disperse the raw materials, cools down to room temperature, and then emulsifies by adding fat and oil to the obtained product can be exemplified.

In the emulsified liquid seasoning of the present invention, salt, vinegar, soy sauce, fruit juice, acidulant, flavor enhancer, protein hydrolysate, saccharides, sweeteners, extracts, flavoring, antioxidants, ingredients (chopped vegetables, grated vegetables, etc.), cheese powder, tomato paste, corn paste, sesame seeds, etc. may be used. By using such raw materials, etc., it is possible to impart the desired taste and texture to the emulsified liquid seasoning of the present invention.

For example, in the case of the emulsified liquid seasoning intended to be produced being a dressing, it is possible to prepare coleslaw dressing, Caesar salad dressing, corn dressing, sesame seed dressing, Japanese style dressing, thousand island dressing, French dressing, etc. using the aforementioned raw materials, etc.

The emulsified liquid seasoning of the present invention preferably adjusts the viscosity to within a predetermined range of values in order to more reliably suppress syneresis and setting. The viscosity of the emulsified liquid seasoning of the present invention is preferably 1000 to 7000 mPa·s, more preferably 1500 to 6000 mPa·s, and most preferably 2000 to 5000 mPa·s. In the case of the viscosity of the emulsified liquid seasoning being lower than these values, emulsion becomes unstable, and there is a possibility of syneresis and separation occurring. On the other hand, in the case of the viscosity of the emulsified liquid seasoning being higher than these values, there is a possibility of setting occurring. In addition, even if the emulsified liquid seasoning is either low viscosity or high viscosity, there is a possibility of hardly dressing with other foodstuff raw materials (for example, vegetables, etc. for a salad).

The viscosity of the emulsified liquid seasoning can be adjusted by a commonly known method. For example, it is possible to set to a desired value by appropriately adjusting the blending amounts of the polysaccharide thickener, fat and oil, crosslinked starch, etc. in the emulsified liquid seasoning.

The emulsified liquid seasoning of the present invention may set the pH to preferably the range of 3.0 to 5.5, and more preferably 3.0 to 4.5, in order to suppress proliferation of bacterium, etc. The pH of the emulsified liquid seasoning can be set to the desired value by appropriately adjusting the blending amounts of vinegar, fruit juice, extracts, flavor enhancer, acidulant, etc.

### EXAMPLES

Hereinafter, the present invention will be explained in detail by way of the Examples; however, the present invention is not to be limited by these Examples.

### Examples 1 to 14

### Comparative Examples 1 to 3

### Coleslaw Dressing Preparation-I

Acetylated adipic acid crosslinked starch (trade name: Coflo 67; manufactured by Nippon NSC Ltd.), starch sodium octenylsuccinate (trade name: Emulstar 500; manufactured by Matsutani Chemical Industry Co., Ltd.), xanthan gum (trade name Eco-Gum GM; manufactured by CP Kelco), tamarind seed gum (trade name: Glyloid 3S; manufactured by Shikibo, Ltd.), high fructose corn syrup and water were charged into a heatable container with a propeller mixer in the blending amounts described in Tables 1 and 2, then heated until the product temperature reached 90° C. while stirring at 100 rpm.

Next, raw materials were dissolved while maintaining the product temperature at 90° C., the remaining raw materials (other than canola oil) were charged, further stirred for 5 minutes, and cooled until the product temperature reached 20° C. Next, while charging canola oil to this little by little, emulsification was performed under conditions of 6500 rpm for 10 minutes in a tabletop homogenizer to produce coleslaw dressing.

It should be noted that “Total (1)” in Tables 1 and 2 indicates the total of the composition of xanthan gum and tamarind seed gum. “Total (2)” indicates the total of all raw material compositions used in the production of coleslaw dressing.

In addition, “%” in the tables hereinafter expresses “mass %”.

### Evaluation

Evaluations were performed on each of the dressings produced based on the following indices.

### (Evaluations of Syneresis and Separation)

To centrifuge tubes of 10 mL size, 10 mL of each dressing was placed, and after performing centrifugation for 8 hours with a centrifugal force of 40×g (15 cm radius, 500 rpm) in a centrifuge, the appearance of the dressing was observed visually and evaluated. The evaluation criteria were as follows.

◯: Syneresis and separation were not recognized

Δ: Slight syneresis and/or separation recognized, but can be used as dressing

x: Syneresis and/or separation clearly recognized

### (Evaluation of Setting)

To beakers with 100 mL size, 50 mL of each dressing was placed, and after leaving to stand and storing for 7 days at 4° C., the fluidity of each dressing was observed visually and evaluated. The evaluation criteria were as follows.

◯: Had fluidity and setting not recognized.

Δ: Fluidity was low, but no setting recognized

x: No fluidity, and setting was recognized

### (Evaluation of Viscosity)

Each dressing was kept at a temperature of 20° C. for 24 hours, and the viscosity was measured using a BM-type viscosimeter. It should be noted that it was made to rotate at 12 rpm using a No. 3 rotor, and the value upon 5 rotations was set as the viscosity. The evaluation criteria were as follows.

◯: viscosity was 1000 to 7000 mPa·s

x: viscosity was less than 1000 mPa·s or more than 7000 mPa·s

### (Flavor Evaluation)

Five panelists participated, and the flavor after holding each dressing (2 ml) in the mouth was scored. The scoring criteria were as follows.

2 points: Both taste and texture more favorable than for 1 point article

1 point: Both taste and texture favorable

0 points: There is off-taste and/or inferior texture

For the scored flavor, the average value was calculated based on the evaluation points of five panelists, and evaluation was performed according to the following criteria.

⊚: 1.6˜2

◯: 1˜1.4

x: 0.8 or less

### (Overall Judgment)

Based on the above-mentioned various evaluations, an overall evaluation was performed for each dressing. The evaluation criteria were as follows.

⊚: Syneresis, separation, setting and viscosity were all ◯, and flavor evaluation was ⊚

◯: Syneresis, separation and setting were all ◯ or Δ

x: Any of syneresis, separation and setting was x

The evaluation results for each coleslaw dressing are shown in Tables 1 and 2.

TABLE 1

| | | | Example 1 | Example 2 | Example 3 | Example 4 | Example 5 |
|---|---|---|---|---|---|---|---|
| Composition | Acetylated adipic acid | | 1.2 | 0.5 | 2.0 | 2.2 | 1.8 |
| (%) | crosslinked starch | | | | | | |
| | Starch sodium octenylsuccinate | | 1.5 | 1.5 | 2.0 | 1.5 | 1.5 |
| | Polysaccharide | Xanthan gum | 0.45 | 0.5 | 0.5 | 0.3 | 0.05 |
| | thickener | Tamarind seed gum | 0 | 0 | 0 | 0 | 0.3 |
| | | Total (1) | 0.45 | 0.5 | 0.5 | 0.3 | 0.35 |
| | High fructose com syrup | | 14 | 15 | 15 | 15 | 15 |
| | (Moisture: 24.5%) | | | | | | |
| | Salad oil | | 12 | 12 | 12 | 12 | 12 |
| | Grain vinegar (Moisture: 90%) | | 11 | 11 | 11 | 11 | 11 |
| | Salt | | 4 | 5 | 5 | 5 | 5 |
| | Sodium glutamate | | 0.4 | 0.4 | 0.4 | 0.4 | 0.4 |
| | Water (Total adjusted to 100%) | | 55.45 | 54.1 | 52.1 | 52.6 | 52.95 |
| | Total (2) | | 100.0 | 100.0 | 100.0 | 100.0 | 100.0 |
| Evaluation | pH | | 3.3 | 3.5 | 3.5 | 3.5 | 3.5 |
| | Syneresis and separation | | ◯ | ◯ | ◯ | ◯ | ◯ |
| | Viscosity | | 4170 | 3250 | 5410 | 3750 | 1240 |
| | | | ◯ | ◯ | ◯ | ◯ | ◯ |
| | Setting | | ◯ | ◯ | ◯ | ◯ | ◯ |
| | Flavor evaluation | | ⊚ | ⊚ | ⊚ | ⊚ | ◯ |
| | Overall judgment | | ⊚ | ⊚ | ⊚ | ⊚ | ◯ |
| | | | | | | | Example |
| | | | Example 6 | Example 7 | Example 8 | Example 9 | 10 |
| Composition | Acetylated adipic acid | | 1.5 | 1.5 | 1.5 | 1.5 | 1.5 |
| (%) | crosslinked starch | | | | | | |
| | Starch sodium octenylsuccinate | | 2.0 | 2.0 | 2.0 | 2.0 | 2.0 |
| | Polysaccharide | Xanthan gum | 0.3 | 0.3 | 0.3 | 0.3 | 0.3 |
| | thickener | Tamarind seed gum | 0 | 0 | 0 | 0 | 0 |
| | | Total (1) | 0.3 | 0.3 | 0.3 | 0.3 | 0.3 |

| | | | | | | |
|---|---|---|---|---|---|---|
| | High fructose com syrup | 15 | 15 | 15 | 15 | 15 |
| | (Moisture: 24.5%) | | | | | |
| | Salad oil | 5 | 8 | 20 | 25 | 30 |
| | Grain vinegar (Moisture: 90%) | 11 | 11 | 11 | 11 | 11 |
| | Salt | 5 | 5 | 5 | 5 | 5 |
| | Sodium glutamate | 0.4 | 0.4 | 0.4 | 0.4 | 0.4 |
| | Water (Total adjusted to 100%) | 59.8 | 56.8 | 44.8 | 39.8 | 34.8 |
| | Total (2) | 100.0 | 100.0 | 100.0 | 100.0 | 100.0 |
| Evaluation | pH | 3.5 | 3.5 | 3.5 | 3.4 | 3.4 |
| | Syneresis and separation | ◯ | ◯ | ◯ | ◯ | ◯ |
| | Viscosity | 1470 | 1580 | 3160 | 3940 | 5680 |
| | | ◯ | ◯ | ◯ | ◯ | ◯ |
| | Setting | ◯ | ◯ | ◯ | ◯ | ◯ |
| | Flavor evaluation | ◯ | ◯ | ⊚ | ⊚ | ⊚ |
| | Overall judgment | ◯ | ◯ | ⊚ | ⊚ | ⊚ |

TABLE 2

| | | | Example | | | | Comparative | Comparative | Comparative |
|---|---|---|---|---|---|---|---|---|---|
| | | | 11 | Example 12 | Example 13 | Example 14 | Example 1 | Example 2 | Example 3 |
| Composition | Acetylated adipic acid | | 2.5 | 1.5 | 1 | 1.8 | 0 | 2 | 2 |
| (%) | crosslinked starch | | | | | | | | |
| | Starch sodium octenylsuccinate | | 1 | 1.5 | 3 | 1.5 | 2 | 0 | 1.5 |
| | Polysaccharide | Xanthan gum | 0.3 | 0.7 | 0.4 | 0 | 0.5 | 0.5 | 0 |
| | thickener | Tamarind seed gum | 0 | 0 | 0 | 0.3 | 0 | 0 | 0 |
| | | Total (1) | 0.3 | 0.7 | 0.4 | 0.3 | 0.5 | 0.5 | 0 |

| | | | | | | | | |
|---|---|---|---|---|---|---|---|---|
| | High fructose corn syrup | 15 | 15 | 15 | 15 | 15 | 15 | 15 |
| | (Moisture: 24.5%) | | | | | | | |
| | Salad oil | 12 | 12 | 12 | 12 | 12 | 12 | 12 |
| | Grain vinegar (Moisture: 90%) | 11 | 11 | 11 | 11 | 11 | 11 | 11 |
| | Salt | 5 | 5 | 5 | 5 | 5 | 5 | 5 |
| | Sodium glutamate | 0.4 | 0.4 | 0.4 | 0.4 | 0.4 | 0.4 | 0.4 |
| | Water (Total adjusted to 100%) | 52.8 | 52.9 | 52.2 | 53 | 54.1 | 54.1 | 53.1 |
| | Total (2) | 100.0 | 100.0 | 100.0 | 100.0 | 100.0 | 100.0 | 100.0 |
| Evaluation | pH | 3.5 | 3.5 | 3.5 | 3.4 | 3.5 | 3.5 | 3.5 |
| | Syneresis and separation | Δ | ◯ | Δ | Δ | X | ◯ | X |
| | | | | | | Syneresis | | Separation |
| | Viscosity | 5400 | 8120 | 1530 | 730 | 2050 | 9450 | 200 |
| | | ◯ | X | ◯ | X | ◯ | X | X |
| | Setting | ◯ | Δ | ◯ | ◯ | ◯ | X | ◯ |
| | Flavor evaluation | X | ◯ | ⊚ | X | ⊚ | X | X |
| | Overall judgment | ◯ | ◯ | ◯ | ◯ | X | X | X |

As shown in Tables 1 and 2, for the emulsified liquid seasoning of the present invention, syneresis, separation and setting were suppressed irrespective of having low fat and oil blending amount and not containing egg yolk.

### Example 15

### Caesar Salad Dressing Preparation-I

Using the raw materials described in Table 3, Caesar salad dressing was prepared according to the same method as the above-mentioned coleslaw dressing. It should be noted that, in regards to the acetylated adipic acid crosslinked starch, starch sodium octenylsuccinate and xanthan gum, the same raw materials as the raw materials used in the preparation of the above-mentioned coleslaw dressing were used.

### Evaluation

Evaluations were performed on the prepared dressings based on the same indices as the above-mentioned coleslaw dressing. The evaluation results thereof are shown in Table 3.

TABLE 3

| | | |
|---|---|---|
| Composition | Acetylated adipic acid | 0.8 |
| (%) | crosslinked starch | |
| | Starch sodium | 1.5 |
| | octenylsuccinate | |
| | Xanthan gum | 0.45 |
| | High fructose corn syrup | 23.0 |
| | (Moisture: 24.5%) | |
| | Salad oil | 12.0 |
| | Grain vinegar | 10.0 |
| | (Moisture: 90%) | |
| | Salt | 6.0 |
| | Sodium glutamate | 0.8 |
| | Cheese powder | 2.0 |
| | Water | 43.45 |
| | (Total adjusted to 100%) | |
| | Total | 100.0 |
| Evaluation | pH | 3.8 |
| | Syneresis and separation | ◯ |
| | Viscosity | 4360 |
| | | ◯ |
| | Setting | ◯ |
| | Flavor evaluation | ⊚ |
| | Overall judgment | ⊚ |

As shown in Table 3, for the emulsified liquid seasoning of the present invention, syneresis, separation and setting were favorably suppressed irrespective of having low fat and oil blending amount and not containing egg yolk.

### Example 16

### Corn Dressing Preparation-I

Using the raw materials described in Table 4, corn dressing was prepared according to the same method as the above-mentioned coleslaw dressing. It should be noted that reduced sugar syrup was charged along with high fructose corn syrup. In addition, in regards to the acetylated adipic acid crosslinked starch, starch sodium octenylsuccinate and xanthan gum, the same raw materials as the raw materials used in the preparation of the above-mentioned coleslaw dressing were used.

### Evaluation

Evaluations were performed on the prepared dressings based on the same indices as the above-mentioned coleslaw dressing. The evaluation results thereof are shown in Table 4.

TABLE 4

| | | |
|---|---|---|
| Composition | Acetylated adipic acid | 1.7 |
| (%) | crosslinked starch | |
| | Starch sodium octenylsuccinate | 2.0 |
| | Xanthan gum | 0.2 |
| | High fructose corn syrup | 22.0 |
| | (Moisture: 24.5) | |
| | Salad oil | 12.0 |
| | Grain vinegar (Moisture: 90%) | 8.0 |
| | Salt | 5.0 |
| | Sodium glutamate | 0.8 |
| | Corn paste | 5.0 |
| | (Moisture: 80%) | |
| | Reduced sugar syrup (Moisture: 30%) | 6.0 |
| | Water (Total adjusted to 100%) | 37.3 |
| | Total | 100.0 |
| Evaluation | pH | 4.0 |
| | Syneresis and separation | ◯ |
| | Viscosity | 2700 |
| | | ◯ |
| | Setting | ◯ |
| | Flavor evaluation | ⊚ |
| | Overall judgment | ⊚ |

As shown in Table 4, for the emulsified liquid seasoning of the present invention, syneresis, separation and setting were favorably suppressed irrespective of having low fat and oil blending amount and not containing egg yolk.

### Example 17

### Sesame Seed Dressing Preparation-I

Using the raw materials described in Table 5, sesame seed dressing was prepared according to the same method as the above-mentioned coleslaw dressing. In addition, in regards to the acetylated adipic acid crosslinked starch, starch sodium octenylsuccinate, xanthan gum and tamarind seed gum, the same raw materials as the raw materials used in the preparation of the above-mentioned coleslaw dressing were used.

### Evaluation

Evaluations were performed on the prepared dressings based on the same indices as the above-mentioned coleslaw dressing. The evaluation results thereof are shown in Table 5.

TABLE 5

| Composition | Acetylated adipic acid | | 1.0 |
|---|---|---|---|
| (%) | crosslinked starch | | |
| | Starch sodium octenylsuccinate | | 1.5 |
| | Polysaccharide | Xanthan gum | 0.1 |
| | thickener | Tamarind seed gum | 0.3 |
| | | Total | 0.4 |

| | | |
|---|---|---|
| | Caster sugar | 17.0 |
| | Salad oil | 11.0 |
| | Grain vinegar (Moisture: 90%) | 11.0 |
| | Salt | 2.0 |
| | Sodium glutamate | 0.5 |
| | Ground sesame (15 mesh) | 6.0 |
| | Soy sauce (Moisture: 69.2%) | 17.0 |
| | Water (Total adjusted to 100%) | 32.6 |
| | Total | 100.0 |
| Evaluation | pH | 4.1 |
| | Syneresis and separation | ◯ |
| | Viscosity | 3550 |
| | | ◯ |
| | Setting | ◯ |
| | Flavor evaluation | ⊚ |
| | Overall judgment | ⊚ |

As shown in Table 5, for the emulsified liquid seasoning of the present invention, syneresis, separation and setting were favorably suppressed irrespective of having low fat and oil blending amount and not containing egg yolk.

### Examples 18 to 25

### Coleslaw Dressing Preparation-II

Using the raw materials described in Table 6, coleslaw dressing was prepared according to the same method as the above-mentioned coleslaw dressing. In addition, in regards to the acetylated adipic acid crosslinked starch, starch sodium octenylsuccinate, xanthan gum and tamarind seed gum, the same raw materials as the raw materials used in the preparation of the above-mentioned coleslaw dressing were used. Moreover, in addition to the raw materials used in the preparation of the above-mentioned coleslaw dressing, acetylated phosphoric acid crosslinked starch (trade name: SMS747; manufactured by Matsutani Chemical Industry Co., Ltd.), hydroxypropylated phosphoric acid crosslinked starch (trade name: Pine Ace #5; manufactured by Matsutani Chemical Industry Co., Ltd.), and guar gum (trade name: VIS TOP D-20; manufactured by San-Ei Gen F.F.I. Inc.) were used.

### Evaluation

Evaluations were performed on each of the prepared dressings based on the same indices as the above-mentioned coleslaw dressing. The evaluation results thereof are shown in Table 6.

TABLE 6

| | | | Example | Example | Example | Example | Example | Example | Example | Example |
|---|---|---|---|---|---|---|---|---|---|---|
| | | | 18 | 19 | 20 | 21 | 22 | 23 | 24 | 25 |
| Composition | Crosslinked | Acetylated adipic acid | | | 1.6 | 1.3 | 1.4 | 1.3 | 1.3 | 1.6 |
| (%) | starch | crosslinked starch | | | | | | | | |
| | | acetylated phosphoric | 1.2 | | | | | | | |
| | | acid crosslinked | | | | | | | | |
| | | starch | | | | | | | | |
| | | hydroxypropylated | | 1.2 | | | | | | |
| | | phosphoric acid | | | | | | | | |
| | | crosslinked starch | | | | | | | | |
| | Starch sodium octenylsuccinate | | 1.5 | 1.5 | 2.0 | 1.7 | 1.7 | 1.7 | 1.7 | 2 |
| | Polysaccharide | Xanthan gum | 0.45 | 0.45 | 0.2 | 0.2 | 0.1 | | 0.3 | 0.45 |
| | thickener | Tamarind seed gum | | | | | | | | |
| | | Guar gum | | | | 0.15 | 0.27 | 0.45 | | |
| | | Total (1) | 0.45 | 0.45 | 0.2 | 0.35 | 0.37 | 0.45 | 0.3 | 0.45 |

| | | | | | | | | |
|---|---|---|---|---|---|---|---|---|
| High fructose com syrup | 14 | 14 | 15 | 15 | 15 | 15 | 15 | 15 |
| (Moisture: 24.5%) | | | | | | | | |
| Salad oil | 12 | 12 | 12 | 12 | 12 | 12 | 1 | 1 |
| Grain vinegar (Moisture 90%) | 11 | 11 | 11 | 11 | 11 | 11 | 11 | 11 |
| Salt | 4 | 4 | 5 | 5 | 5 | 5 | 5 | 5 |
| Sodium glutamate | 0.4 | 0.4 | 0.4 | 0.4 | 0.4 | 0.4 | 0.4 | 0.4 |
| Water (Total adjusted to 100%) | 55.45 | 55.45 | 52.8 | 53.25 | 53.13 | 53.15 | 64.3 | 63.55 |
| Total (2) | 100.0 | 100.0 | 100.0 | 100.0 | 100.0 | 100.0 | 100.0 | 100.0 |

| | | | | | | | | | |
|---|---|---|---|---|---|---|---|---|---|
| Evaluation | pH | 3.5 | 3.5 | 3.5 | 3.4 | 3.4 | 3.5 | 3.5 | 3.5 |
| | Syneresis and | ◯ | ◯ | ◯ | ◯ | ◯ | ◯ | ◯ | ◯ |
| | separation | | | | | | | | |
| | Viscosity | 1700 | 4000 | 1310 | 2600 | 2160 | 1850 | 1300 | 2510 |
| | | ◯ | ◯ | ◯ | ◯ | ◯ | ◯ | ◯ | ◯ |
| | Setting | ◯ | ◯ | ◯ | ◯ | ◯ | ◯ | ◯ | ◯ |
| | Flavor evaluation | ⊚ | ⊚ | ⊚ | ⊚ | ⊚ | ⊚ | ◯ | ◯ |
| | Overall judgment | ⊚ | ⊚ | ⊚ | ⊚ | ⊚ | ⊚ | ◯ | ◯ |

As shown in Table 6, for the emulsified liquid seasoning of the present invention, syneresis, separation and setting were favorably suppressed irrespective of having low fat and oil blending amount and not containing egg yolk.

### Example 26

### Caesar Salad Dressing Preparation-II

Using the raw materials described in Table 7, Caesar salad dressing was prepared according to the same method as the above-mentioned coleslaw dressing. In addition, in regards to the acetylated adipic acid crosslinked starch, starch sodium octenylsuccinate and xanthan gum, the same raw materials as the raw materials used in the preparation of the above-mentioned coleslaw dressing were used.

### Evaluation

Evaluations were performed on the prepared dressings based on the same indices as the above-mentioned coleslaw dressing. The evaluation results thereof are shown in Table 7.

TABLE 7

| | | |
|---|---|---|
| Composition | Acetylated adipic acid crosslinked starch | 1.7 |
| (%) | Starch sodium octenylsuccinate | 2.0 |
| | Xanthan gum | 0.2 |
| | High fructose corn syrup (Moisture: 24.5%) | 23.0 |
| | Salad oil | 12.0 |
| | Grain vinegar (Moisture: 90%) | 10.0 |
| | Salt | 6.0 |
| | Sodium glutamate | 0.8 |
| | Cheese powder | 2.0 |
| | Black pepper | 0.15 |
| | Water (Total adjusted to 100%) | 42.15 |
| | Total | 100.0 |
| Evaluation | pH | 3.8 |
| | Syneresis and separation | ◯ |
| | Viscosity | 2430 |
| | | ◯ |
| | Setting | ◯ |
| | Flavor evaluation | ⊚ |
| | Overall judgment | ⊚ |

As shown in Table 7, for the emulsified liquid seasoning of the present invention, syneresis, separation and setting were favorably suppressed irrespective of having low fat and oil blending amount and not containing egg yolk.

### Example 27

### Corn Dressing Preparation-II

Using the raw materials described in Table 8, corn dressing was prepared according to the same method as the above-mentioned coleslaw dressing. In addition, in regards to the acetylated adipic acid crosslinked starch, starch sodium octenylsuccinate and xanthan gum, the same raw materials as the raw materials used in the preparation of the above-mentioned coleslaw dressing were used.

### Evaluation

Evaluations were performed on the prepared dressings based on the same indices as the above-mentioned coleslaw dressing. The evaluation results thereof are shown in Table 8.

TABLE 8

| | | |
|---|---|---|
| Composition | Acetylated adipic acid crosslinked starch | 0.8 |
| (%) | Starch sodium octenylsuccinate | 1.5 |
| | Xanthan gum | 0.45 |
| | High fructose corn syrup (Moisture: 24.5%) | 22.0 |
| | Salad oil | 12.0 |
| | Grain vinegar (Moisture: 90%) | 8.0 |
| | Salt | 5.0 |
| | Sodium glutamate | 0.8 |
| | Corn paste (Moisture: 80%) | 5.0 |
| | Reduced sugar syrup (Moisture: 30%) | 6.0 |
| | Water (Total adjusted to 100%) | 38.45 |
| | Total | 100.0 |
| Evaluation | pH | 3.8 |
| | Syneresis and separation | ◯ |
| | Viscosity | 5100 |
| | | ◯ |
| | Setting | ◯ |
| | Flavor evaluation | ⊚ |
| | Overall judgment | ⊚ |

As shown in Table 8, for the emulsified liquid seasoning of the present invention, syneresis, separation and setting were favorably suppressed irrespective of having low fat and oil blending amount and not containing egg yolk.

### Example 28

### Sesame Seed Dressing Preparation-II

Using the raw materials described in Table 9, sesame seed dressing was prepared according to the same method as the above-mentioned coleslaw dressing. It should be noted that, in regards to the acetylated adipic acid crosslinked starch, starch sodium octenylsuccinate, xanthan gum and tamarind seed gum, the same raw materials as the raw materials used in the preparation of the above-mentioned coleslaw dressing were used.

### Evaluation

Evaluations were performed on the prepared dressings based on the same indices as the above-mentioned coleslaw dressing. The evaluation results thereof are shown in Table 9.

TABLE 9

| Composition | Acetylated adipic acid crosslinked starch | | 1.7 |
|---|---|---|---|
| (%) | Starch sodium octenylsuccinate | | 2.0 |
| | Polysaccharide | Xanthan gum | 0.1 |
| | thickener | Tamarind seed gum | 0.1 |
| | | Total | 0.2 |

| | | |
|---|---|---|
| | Caster sugar | 17.0 |
| | Salad oil | 12.0 |
| | Grain vinegar (Moisture: 90%) | 11.0 |
| | Salt | 1.7 |
| | Sodium glutamate | 0.5 |
| | Ground sesame (15 mesh) | 6.0 |
| | Soy sauce (Moisture: 69.2%) | 17.0 |
| | Water (Total adjusted to 100%) | 30.9 |
| | Total | 100.0 |
| Evaluation | pH | 4.0 |
| | Syneresis and separation | ◯ |
| | Viscosity | 3340 |
| | | ◯ |
| | Setting | ◯ |
| | Flavor evaluation | ◯ |
| | Overall judgment | ◯ |

As shown in Table 9, for the emulsified liquid seasoning of the present invention, syneresis, separation and setting were favorably suppressed irrespective of having low fat and oil blending amount and not containing egg yolk.

1. An emulsified liquid seasoning comprising: a crosslinked starch; octenyl succinate-treated starch; and polysaccharide thickener.

2. The emulsified liquid seasoning according to claim 1, comprising in terms of total amount of emulsifier liquid seasoning, 0.3 to 2.2 mass % of the crosslinked starch; 0.5 to 2.5 mass % of the octenyl succinate-treated starch; and 0.2 to 0.6 mass % of the polysaccharide thickener.

3. The emulsified liquid seasoning according to claim 1, wherein the crosslinked starch is acetylated adipic acid crosslinked starch, and the octenyl succinate-treated starch is starch sodium octenylsuccinate.

4. The emulsified liquid seasoning according to claim 2, wherein the crosslinked starch is acetylated adipic acid crosslinked starch, and the octenyl succinate-treated starch is starch sodium octenylsuccinate.

5. The emulsified liquid seasoning according to claim 1, wherein the polysaccharide thickener is selected from the group consisting of xanthan gum, tamarind seed gum, and mixtures thereof.

6. The emulsified liquid seasoning according to claim 2, wherein the polysaccharide thickener is selected from the group consisting of xanthan gum, tamarind seed gum, and mixtures thereof.

7. The emulsified liquid seasoning according to claim 3, wherein the polysaccharide thickener is selected from the group consisting of xanthan gum, tamarind seed gum, and mixtures thereof.

8. The emulsified liquid seasoning according to claim 4, wherein the polysaccharide thickener is selected from the group consisting of xanthan gum, tamarind seed gum, and mixtures thereof.

9. The emulsified liquid seasoning according claim 1, comprising 1 to 30 mass % fat and oil in terms of total amount of emulsified liquid seasoning, wherein the fat and oil are liquid at 20° C.

10. The emulsified liquid seasoning according claim 2, comprising 1 to 30 mass % fat and oil in terms of total amount of emulsified liquid seasoning, wherein the fat and oil are liquid at 20° C.

11. The emulsified liquid seasoning according claim 3, comprising 1 to 30 mass % fat and oil in terms of total amount of emulsified liquid seasoning, wherein the fat and oil are liquid at 20° C.

12. The emulsified liquid seasoning according claim 4, comprising 1 to 30 mass % fat and oil in terms of total amount of emulsified liquid seasoning, wherein the fat and oil are liquid at 20° C.

13. The emulsified liquid seasoning according claim 5, comprising 1 to 30 mass % fat and oil in terms of total amount of emulsified liquid seasoning, wherein the fat and oil are liquid at 20° C.

14. The emulsified liquid seasoning according claim 6, comprising 1 to 30 mass % fat and oil in terms of total amount of emulsified liquid seasoning, wherein the fat and oil are liquid at 20° C.

15. The emulsified liquid seasoning according claim 7, comprising 1 to 30 mass % fat and oil in terms of total amount of emulsified liquid seasoning, wherein the fat and oil are liquid at 20° C.

16. The emulsified liquid seasoning according claim 8, comprising 1 to 30 mass % fat and oil in terms of total amount of emulsified liquid seasoning, wherein the fat and oil are liquid at 20° C.
